(19) United States
(12) Patent Application Publication
(10) Pub. No.: US 2023/0214862 A1
(43) Pub. Date: Jul. 6, 2023

(54) IMPROVEMENTS IN OR RELATING TO CONSUMER INSIGHTS

(71) Applicant: Givaudan SA, VERNIER (CH)

(72) Inventors: Kimberly DUNCAN, Union, KY (US); Natalie TAAKE, Cincinnati, OH (US); David BUSBY, Lewisville, NC (US); James JACKSON-ADAMS, Greensboro, NC (US)

(21) Appl. No.: 17/999,243

(22) PCT Filed: May 19, 2021
(86) PCT No.: PCT/EP2021/063376

§ 371 Date: Nov. 18, 2022

Related U.S. Application Data
(60) Provisional application No. 63/028,952, filed on May 22, 2020.

(51) Int. Cl. G06Q 30/0204

(52) U.S. Cl. CPC G06Q 30/0204

(57) ABSTRACT

Methods and systems provide for assessing likelihood of market success of a flavor. One embodiment of a method includes (a) collecting input information from a consumer regarding at least one food related preference; (b) analyzing the input information using a computer algorithm in order to assign the consumer to one of a plurality of distinct consumer segments based on the consumer's food related preferences; (c) collecting input information from the consumer regarding preference level of at least one flavor for a particular consumable product; (d) analyzing the input information and assigning the preference level of the at least one flavor within each distinct consumer segment; and (e) determining the impact of the at least one flavor within each distinct consumer segment.

### FIELD OF THE INVENTION

The present disclosure relates generally to methods and systems for improving consumer insights. More particularly, the present disclosure relates to methods and systems for categorization of flavors that can provide feedback relating to a company's products and brands.

A portion of the disclosure of this patent document contains material which is subject to copyright protection. The copyright owner has no objection to the reproduction by anyone of the patent document or the patent disclosure, as it appears in the Patent and Trademark Office patent file or records, but otherwise reserves all copyright rights whatsoever.

### BACKGROUND OF THE INVENTION

The commercial success of a consumable is dependent, at least in part, upon the manner in which it evokes a positive response from a consumer. However, such is not an easy task, given the fluctuation of consumer eating behavior as a whole population and individually. Thus, producers often engage in expensive and time-consuming market research to determine the most appropriate product or service, in an effort to avoid introducing inappropriate products to the market. Further, market researchers and/or producers have typically performed market research for each type of product, a time-consuming and expensive process.

Traditional segmentations focus broadly on attitudes, behaviors, and needs of consumers within a product category and may correctly identify distinct groups of consumers, but they do little to solve the problem of the “flavor flop.” A widely recognized but poorly understood phenomenon, the flavor flop refers to when a company seeks to appease as many consumers as possible through a “one size fits all” approach yet fails to meaningfully engage any of their targeted markets.

Just as consumers' tastes vary, a trend for one is not a trend for all. Decades of survey research have borne this out as a law of the market. Market research continues to evolve as a vital tool for gaining a competitive advantage, and while segmenting consumer markets into meaningful subgroups is an essential starting point, a more refined, multi-dimensional approach can yield actionable findings that traditional segmentation methodologies cannot.

Accordingly, there is a demand to provide food and beverage companies the ability to find the right flavor for the right consumer.

### SUMMARY OF THE INVENTION

In one illustrative embodiment, a method of assessing likelihood of market success of a flavor for a consumable product comprises the steps of: (a) collecting input information from a consumer regarding at least one food related preference; (b) analyzing the input information using a computer algorithm in order to assign the consumer to one of a plurality of distinct consumer segments based on the consumer's food related preferences; (c) collecting input information from the consumer regarding preference level of at least one flavor for a particular consumable product; (d) analyzing the input information and assigning the preference level of the at least one flavor within each distinct consumer segment; and (e) determining the impact of the at least one flavor within each distinct consumer segment.

In another illustrative embodiment, a method, executable by at least one processor, for assessing market success of a flavor for a consumable product comprises the steps of: (a) receiving, by the at least one processor, input information from a consumer related to the consumer's food related preferences; (b) calculating for each consumer, by the at least one processor, a segment membership probability score for each segment and assigning the segment with the highest score to the consumer; (c) receiving, by the at least one processor, input information from the consumer regarding preference level of at least one flavor for a particular consumable product; (d) calculating, by the at least one processor, a flavor preference score corresponding to the preference level of the at least one flavor within each distinct consumer segment; (e) generating, by the at least one processor, a flavor strategy report, including the impact of the at least one flavor within each distinct consumer segment; and (f) outputting, by the at least one processor, the flavor strategy report.

In a further illustrative embodiment, a system for assessing likelihood of market success of a flavor for a consumable product comprises one or more computing devices comprising one or more processors and one or more non-transitory storage devices for storing instructions, wherein execution of the instructions by the one or more processors causes the one or more computing devices to process a collection of information received from one or more consumers regarding at least one food related preference and/or a preference level of at least one flavor for a particular consumable product, and to execute a clustering function to generate one or more segmentation clusters based on the collection of received information.

These and other features, aspects and advantages of specific embodiments will become evident to those skilled in the art from a reading of the present disclosure.

### BRIEF DESCRIPTION OF THE DRAWINGS

The embodiments set forth in the drawings are illustrative in nature and not intended to limit the invention defined by the claims. The following detailed description of the illustrative embodiments can be understood when read in conjunction with the following drawings, where like structure is indicated with like reference numerals and in which:

FIG. 1 is a flow diagram of the method for assessing likelihood of market success of a flavor according to embodiments shown and described herein.

### DETAILED DESCRIPTION OF THE INVENTION

The following text sets forth a broad description of numerous different embodiments of the present disclosure. The description is to be construed as exemplary only and does not describe every possible embodiment since describing every possible embodiment would be impractical, if not impossible. It will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims. All publications and patents cited herein are incorporated herein by reference.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term or “exemplary” or “illustrative” is used herein to mean “serving as an example, instance or illustration.” Any embodiment or design described herein as “exemplary” or “illustrative” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

According to the present disclosure, the term “consumable” refers to products for consumption by a subject, typically via the oral cavity (although consumption may occur via non-oral means such as inhalation), for at least one of the purposes of enjoyment, nourishment, or health and wellness benefits. Consumables may be present in any form including, but not limited to, liquids, solids, semi-solids, tablets, capsules, lozenges, strips, powders, gels, gums, pastes, slurries, solutions, suspensions, syrups, aerosols and sprays. The term also refers to, for example, dietary and nutritional, and health and wellness supplements. Consumables include compositions that are placed within the oral cavity for a period of time before being discarded but not swallowed. It may be placed in the mouth before being consumed, or it may be held in the mouth for a period of time before being discarded.

Broadly, consumables include, but are not limited to, comestibles of all kinds, confectionery products, baked products, sweet products, savory products, fermented products, dairy products, non-dairy products, beverages, nutraceuticals and pharmaceuticals.

According to the present disclosure, methods are described for assessing likelihood of market success of a flavor for a consumable product. The “one size fits all” approach no longer applies to flavors, instead, it is necessary to find the right flavor for the right consumer. Understanding how to meet your consumers where they are on the adoption curve can help identify the next big flavor trend or successfully bring a new product to market. For example, a consumer more predisposed to experimentation, or an early adopter on a standard adoption curve (i.e. experimentation, validation, acceptance, mass appeal) might consider chocolate-covered crickets when “trying something new.” On the other hand, to a consumer who leans towards more familiar and known flavors, “trying something new” might mean trying a different brand of barbecue sauce.

By “flavor” it is meant a composition created by a flavorist using methods known to the skilled person that is a mixture of tastants, aroma compounds and sensates. Examples of suitable flavors include natural flavors, artificial flavors, spices, seasonings, and the like. Exemplary flavors include synthetic or natural flavor oils and flavoring aromatics and/or oils, oleoresins, essences, and distillates, and a combination comprising at least one of the foregoing. Generally any flavor or food additive such as those described in “Chemicals Used in Food Processing”, Publication No 1274, pages 63-258, by the National Academy of Sciences, can be used. This publication is incorporated herein by reference.

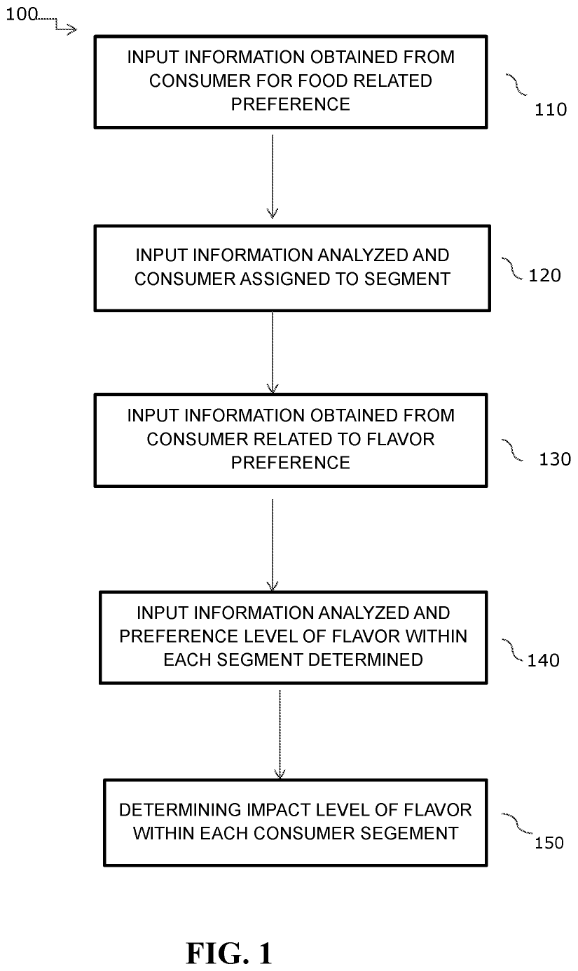

Referring now to FIG. 1, method 100 for assessing likelihood of market success of a flavor for a consumable product includes the steps of: step 110, collecting input information from a consumer regarding at least one food related preference; step 120, analyzing the input information using a computer algorithm in order to assign the consumer to one of a plurality of distinct consumer segments based on the consumer's food related preferences; step 130, collecting input information from the consumer regarding preference level of at least one flavor for a particular consumable product; step 140, analyzing the input information and assigning the preference level of the at least one flavor within each distinct consumer segment; and step 150, determining the impact of the at least one flavor within each distinct consumer segment.

Referring to FIG. 1, step 110 depicts the step of collecting input information from a consumer regarding at least one food related preference. In one embodiment, input information may be collected from a consumer by a self-report, i.e., questioning means, that is, by the consumer's answering questions, which are asked of him or her, either orally or in written form, or electronically, such as via a computing device. The questioning means may be an interviewer asking oral questions of the consumer, for example, an interview in a shopping mall, a written questionnaire on which the consumer writes answers to the written questions, an electronic questionnaire viewed by the consumer on a computing device and for which the consumer submits answers to the questions by typing on a keyboard, touching a responsive screen, speaking an answer, or the like, or the information may be collected from a consumer through the use of an interactive website.

With regard to step 110, the precise manner and wording chosen to collect input information from the consumer may vary depending on local custom, the comfort level of consumers in discussing food related preferences, and the meaning associated with terms which may be used in different parts of the world to collect information desired. It is to be further understood that the methods of the present disclosure are not to be limited to any one type of question asking methodology or philosophy.

In one embodiment, the term computing device refers to any portable device capable of running one or more software applications and also can be connected to the Internet or one or more computer networks. User computing devices include, but are not limited to, computer laptops, smartphones (for example, iPhone or Android), tablets, netbooks, GPS devices, e-readers, iPads, and mobile game consoles (for example, Nintendo DS, Nintendo Switch, Sony PSP). The computing device may further include at least one processor, which may be configured to run various software applications (e.g. operating systems, programs, and/or “apps”) or computer code stored in memory. The processor may be configured to perform any of the operations disclosed in the present disclosure.

Still referring to FIG. 1, in one embodiment, step 110 also includes collecting information regarding food related preferences. As discussed above, a consumer may be asked a series of questions, each relating to their food related preferences, including, but not limited to: foodie attributes (“I will pay more for food that is premium/gourmet”, “When ordering/preparing a meal, I carefully select foods/beverages that complement each other to make the overall meal experience better”, etc.); neophobia (the fear of or unwillingness to try something new); attributes (“I'm constantly sampling new and different foods”, “I don't trust new foods”, “I'm very particular about the foods I will eat”); perception of what is considered “different” or “unique”; food and beverage comfort zones; and preferred flavors and foods.

For some questions, consumers are asked “How much you agree or disagree that each statement below describes you” ranging from “1—Does not describe me at all” to “10—Describes me completely.” In another example, consumers are asked “Please indicate how much you agree or disagree with each statement” choosing from “1—Strongly disagree, 2—Somewhat disagree, 3—Neither agree nor disagree, 4—Somewhat agree, and 5—Strongly agree.”

In one embodiment, the processor may be configured to receive input information from a consumer related to the consumer's food related preferences. In one embodiment, consumers may use one or more input/output devices, for example, a touchpad, button, keyboard, speaker, sensor, which may be communicatively coupled with the processor.

Referring to FIG. 1, step 120, analyzing the input information from step 110, may be performed, at least in part, with the aid of computer hardware and software. For example, the computer may receive input information from step 110 and then perform additional calculations or actions automatically. In another embodiment, the automated real-time data analysis of the input information of the consumer may be performed using a software algorithm loaded onto a computing device. An example of such software is cluster assignment software that utilizes a typing tool in order to calculate a segment membership probability score for each consumer for each segment as discussed below. In one embodiment, a typing tool is a computer or mathematical algorithm that assigns or classifies respondents into segments based on the respondents answers to a set of questions.

According to certain embodiments, the present disclosure utilizes at least one clustering algorithm to assess likelihood of market success of a flavor for a consumable product. Suitable clustering algorithms are well known to those of ordinary skill in the art. Many different methods are known for clustering information, such as, but not limited to, k-means clustering algorithms, hierarchical clustering algorithms, means-drift clustering algorithms, distance-based clustering algorithms, density-based clustering algorithms, convergent cluster analysis, cluster ensemble analysis and/or the like. Other forms of machine learning algorithms are encompassed by this disclosure. An illustrative k-means analysis includes the following steps:

i) identifying an initial set of cluster centroids;

ii) classifying each respondent to the closest cluster centroid;

iii) calculating resulting clusters;

iv) recalculating cluster centroids; and

v) repeating steps ii) through iv) until no respondents re-classify.

According to certain embodiments, the present disclosure utilizes Convergent Cluster & Ensemble Analysis Software (“CCEA”), available through Sawtooth Software, Inc. (Provo, Utah). The CCEA software cluster analysis (a way of categorizing a collection of objects, like survey respondents into groups or clusters) and ensemble analysis (leverages multiple cluster solutions to find a consensus) analyzes the data collected from consumers in real-time. See e.g., Bryan Orme, et al., “Improving K-Means Cluster Analysis: Ensemble Analysis Instead of Highest Reproducibility Replicates”, Sawtooth Software Research Paper Series, 2008.

In one embodiment, there is a computer or mathematical algorithm for each segment used in the assessment of probability of membership to a segment. Each algorithm produces a membership probability score, the scores are compared across segments and then the respondent/consumer is assigned to the segment with the highest score. The segment membership probability score may be a numerical value calculated based on a consumer's responses to questions in step 110 and is a rank of segment relevancy.

Step 120 results in a consumer being assigned to one of a plurality of distinct consumer segments based on the data analyzed. In accordance with the present disclosure, this analysis resulted in four unique consumer types, none of which were driven by demographics. The demographic makeup of each group is similar; there is no unique defining trait related to age, gender, etc. in any of the groups. Instead, these groupings are a function of the choices, behaviors, and attitudes of each group. Furthermore, the ability to segment consumers into these groups is highly accurate; the typing accuracy (the ability to accurately type consumers into the correct segment) of each segment ranges from 83%-93%, above the 70-80% accuracy that is not uncommon for individual segments within a segmentation solution. In one embodiment, the plurality of distinct consumer segments is selected from the group consisting of trailblazer, investigator, follower and hesitator.

So in practice, for example, based on the input information from step 110, the algorithms may calculate the following segment probability scores for a first consumer: Trailblazer (49.6644); Investigator (47.8479); Follower (36.7664) and Hesitator (44.7401). As a result, the first consumer would be assigned to the Trailblazer segment because that segment produced the highest score. In another example, the algorithms may calculate the following segment probability scores for a second consumer: Trailblazer (34.6531); Investigator (33.4755); Follower (30.2481) and Hesitator (41.1582). As a result, the second consumer would be assigned to the Hesitator segment because that segment produced the highest score.

More specifically, the flavor focused consumer segments may be described as follows:

TABLE I

| | |
|---|---|
| TRAILBLAZER | Influencer and leader in peer group. |
| | Food preferences are characterized |
| | by experimentation and broadening |
| | their horizons. Stray from the norm, |
| | going out of their way to try trendy |
| | restaurants and dishes and share |
| | those experiences with others. |
| | Tend to shy away from |
| | conventional, “safe” flavors and are |
| | willing to take risks, gravitating |
| | towards bold, unusual, fresh, and |
| | flavorful foods. |
| | At the grocery store, Trailblazers |
| | explore the aisles looking for out- |
| | of-the-box, distinctively different |
| | offerings to take home and try. |
| INVESTIGATOR | Early adopter of new foods and also |
| | willing to take risks on bold new |
| | flavors. But have high standards for |
| | food and beverages and seek to |
| | understand the story behind the |
| | food. |
| | Will pay more for high-quality |
| | ingredients and are not afraid to be |
| | particular about eating. |
| | More likely to seek out new vegan |
| | and vegetarian dishes. |
| | Prefer local restaurants over |
| | national chains. |
| FOLLOWER | modus operandi is one of |
| | moderation - willing to experiment, |
| | but only so far and typically define |
| | “trying something new” as trying a |
| | variation on a classic. |
| | Often brand and product loyal but |
| | will take into consideration word- |
| | of-mouth recommendations or |
| | consult online reviews to guide their |
| | decision-making. |
| | Prefer chain restaurants. |
| HESITATOR | Defined by considerations that are |
| | less flavor-centric and more habit- |
| | based. “Like what they like” and are |
| | not comfortable trying new-to-them |
| | foods. |
| | Not wholly unwilling to try new |
| | flavors, foods, or restaurants - they |
| | just require more time and |
| | convincing to experiment outside of |
| | comfort zone. Often, “new things” |
| | are not actually new to the market, |
| | just new to them. |
| | Tend to be habitual and |
| | convenience oriented in choice of |
| | restaurants and stores. |

In accordance with one embodiment, one key difference of the segmentation of step 120 is the purposeful de-prioritization of demographic information (age, gender, etc.). The applicants hypothesized that flavors are demographics-agnostic; rather than setting somewhat arbitrary boundaries based on a demographic target (e.g., millennials, men, parents, Hispanic consumers, college-educated, etc.), consumers should be targeted based on where they fall on a flavor-focused adoption curve. According to the present disclosure, no segment is defined by a specific demographic. There are similar breakdowns of male/female, age, and other characteristics across the segments.

In one embodiment, the processor may be configured to determine a distinct consumer segment to assign the consumer based on the input information.

After having collected and analyzed the input information from a consumer as described above, step 130 of method 100 calls for collecting input information from the consumer regarding preference level of at least one flavor for a particular consumable product. A consumer may be asked question(s), each relating to their preference level of at least one flavor food related preference level. For example, consumers may be asked “How likely you would be to purchase that flavor (e.g. ginger spice) of consumable (e.g. whiskey/bourbon)” ranging from “definitely/probably would buy” to “definitely/probably would not buy.” In one embodiment, a processor may be configured to receive input information from a consumer related to the consumer's flavor preferences. In one embodiment, consumers may use one or more input/output devices, for example, a touchpad, button, keyboard, speaker, sensor, which may be communicatively coupled with the processor.

After collecting the information from step 130, the input information is analyzed in order to assign the preference level of the at least one flavor within each distinct consumer segment in step 140. Referring to FIG. 1, step 140, analyzing the input information from step 130, may be performed, at least in part, with the aid of computer hardware and software. Finally, method 100 calls for step 150, determining the impact of the at least one flavor within each distinct consumer segment, i.e. is the flavor selected the right flavor for the consumers of interest. The goal of method 100 is to place food or beverage companies in a position to increase the likelihood of market success when introducing a new, unique or unconventional flavor.

In another embodiment, step 140 includes calculating with a processor, a flavor preference score corresponding to the preference level of the at least one flavor within each distinct consumer segment and generating a flavor strategy report, including the impact of the at least one flavor within each distinct consumer segment.

The present disclosure can be implemented in software in combination with hardware and/or firmware. For example, the present disclosure may be implemented in software executed by one or more processors. According to one embodiment, the present disclosure may be implemented using a non-transitory computer readable medium having stored thereon computer executable instructions that when executed by the processor of a computer controls the computer to perform steps. Exemplary computer readable media suitable for implementing the present disclosure include non-transitory computer readable media, such as disk memory devices, chip memory devices, programmable logic devices, and application specific integrated circuits. In addition, a computer readable medium that implements the present disclosure may be located on a single device, a computing platform, or may be distributed across multiple devices and/or computing platforms.

The present disclosure may be implemented using the below particular machines, and those hereinafter developed, in any suitable combination, as would be appreciated by one of ordinary skill in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the FIGURES contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include customer data and/or like data useful in the operation of the system.

Certain illustrative embodiments relate to one or more computer systems capable of carrying out the functionality described herein. The computer system may include one or more processors. The processor is connected to a communication infrastructure (e.g., a communications bus, cross over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure for display on a display unit.

Computer system may also include a main memory, such as for example random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

The present disclosure may be described herein in terms of functional block components and various processing steps. It will be understood that each functional block of the block diagrams and the flowchart illustrations, and combinations of functional blocks in the block diagrams and flowchart illustrations, respectively, can be implemented by computer program instructions. For example, the system may employ various integrated circuit components, e.g., memory elements, processing elements, logic elements, look-up tables, and the like, which may carry out a variety of functions under the control of one or more processors or other control devices. Similarly, the software elements of the system may be implemented with any programming or scripting language with the various algorithms being implemented with any combination of data structures, objects, processes, routines or other programming elements. Further, it should be noted that the system may employ any number of conventional techniques for data transmission, signaling, data processing, network control, and the like.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

In one embodiment, analyzing the information from step 140 may be presented as follows:

TABLE II

| | Total | | | | |
|---|---|---|---|---|---|
| Consumers that indicate | Whiskey/Bourbon | | | | |
| “definitely/probably | Users | Trailblazer | Investigator | Follower | Hesitator |
| would buy” | n = 66 | n = 20 | n = 20 | n = 20 | n = 6* |
| Almond butter | 48% | 70% | 50% | 35% | — |
| Apricot | 50% | 75% | 55% | 30% | — |
| Black Strap Molasses | 47% | 75% | 35% | 40% | — |
| Blackberry Bramble | 71% | 85% | 75% | 55% | — |
| Coffee | 62% | 75% | 70% | 50% | — |
| Cracked Pepper | 39% | 65% | 35% | 20% | — |
| Ginger Spice | 62% | 70% | 50% | 65% | — |
| Lemon Rosemary | 56% | 70% | 55% | 50% | — |
| Orange Bitters | 67% | 85% | 60% | 60% | — |
| Peanut | 44% | 70% | 45% | 25% | — |
| Smoked Honey | 52% | 70% | 60% | 35% | — |
| Trail Mix (chocolate, | 48% | 75% | 55% | 30% | — |
| nuts, dried fruit) | | | | | |
| Vanilla Cinnamon | 71% | 80% | 65% | 70% | — |

*sample size too small

As shown in Table II, typical market research would look at just the “Total” column and come away with the conclusion that Blackberry Bramble and Vanilla Cinnamon would be the most impactful “new” flavor if a company launched a whiskey/bourbon flavored with either of these. However, according to the present disclosure, a beverage company could use method 100 and realize that if they wanted to launch Orange Bitters or Coffee flavored whiskey/bourbon then they would need to target consumers that are Trailblazers to be successful. Prior to method 100, a beverage company would have no reason to believe that a launch of Orange Bitters or Coffee flavored whiskey/bourbon might be a good choice.

In another embodiment, input information from a consumer related to a preference level of at least one flavor for a particular consumable product may be received by at least one processor, followed by calculating a flavor preference score corresponding to the preference level of the at least one flavor within each distinct consumer segment. In one example, the more a consumer prefers a flavor, the higher the flavor preference score for that flavor. Further, the flavor preference score may be a numerical value calculated based on a consumer's responses to questions in step 130 and is a rank of flavor relevancy, i.e. the higher the score, the more relevant the flavor is to the consumer. For example, in Table II, the flavor preference score is indicated as a percentage (%). Based on the consumer segment score and the flavor preference score, a flavor strategy report may be generated showing the impact of the at least one flavor within each distinct consumer segment. This report could take any one of a number of formats, including for example, a written report, print-out, or graphical interface outputted to an imaging device.

Using the above-described method, the following exemplary implementation of the method may be performed. A beverage company is interested in launching a new sparkling water product or line extension. The beverage company thinks that it would be a good idea to launch a “Blood Orange” flavor for this new product or line extension. According to the method of the present disclosure, the beverage company will be able to gauge whether its new product or line extension will appeal to its consumers and lead to success in the market.

First, ABC beverage company will collect input information from its consumers according to step 110 (in one example it may be a central location test or online test); next, the input information will be analyzed using a computer algorithm and the consumers will be assigned to one of a plurality of distinct consumer segments according to step 120. For purposes of this example, ABC beverage company consumers typically received the highest segment membership score in the “Hesitator” segment and thus were assigned to the “Hesitator” segment; next, according to step 130, ABC beverage company will collect input information from its consumers regarding the preference level of “Blood-orange” for sparkling water; next, the preference level of “Blood-orange” for sparkling water within each consumer segment is determined by asking, for example, “How likely you would be to purchase that ‘Blood-orange’ sparkling water”. For purposes of this example, “Blood-orange” flavor is preferred by consumers within the “Trailblazer” or “Investigator” segment; finally ABC beverage company determines the impact of the “Blood-orange” flavor for sparkling water.

In the present example, since the consumer segments do not match, ABC beverage company will have a difficult time convincing its “Hesitator” consumers to accept a “Blood-orange” sparkling water product. As a result, ABC beverage company would likely explore other available flavors that fall into the “Hesitator” segment or come up with a strategy to target the “Trailblazer” or “Investigator” segment in order to maximum its likelihood of market success.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern. Although the present disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A method of assessing likelihood of market success of a flavor for a consumable product comprising the steps of:
(a) collecting input information from a consumer regarding at least one food related preference;
(b) analyzing the input information of step (a) using a computer algorithm in order to assign the consumer to one of a plurality of distinct consumer segments based on the consumer's food related preferences;
(c) collecting input information from the consumer regarding preference level of at least one flavor for a particular consumable product;
(d) analyzing the input information of step (c) and assigning the preference level of the at least one flavor within each distinct consumer segment; and
(e) determining the impact of the at least one flavor within each distinct consumer segment.

2. The method according to claim 1, wherein the input information is obtained from the consumer by questioning means.

3. The method according to claim 1, wherein step (b) includes an automated data analysis.

4. The method according to claim 3, wherein the automated data analysis is performed using software.

5. The method according to claim 4, wherein the software is cluster assignment software that utilizes a typing tool to calculate a segment membership probability score for each consumer for each segment.

6. The method according to claim 1, wherein the plurality of distinct consumer segments is selected from the group consisting of trailblazer, investigator, follower and hesitator.

7. A method, executable by at least one processor, for assessing market success of a flavor for a consumable product, the method comprising:
(a) receiving, by the at least one processor, input information from a consumer related to the consumer's food related preferences;
(b) calculating for each consumer, by the at least one processor, a segment membership probability score for each distinct consumer segment and assigning the segment with the highest score to the consumer;
(c) receiving, by the at least one processor, input information from the consumer regarding preference level of at least one flavor for a particular consumable product;
(d) calculating, by the at least one processor, a flavor preference score corresponding to the preference level of the at least one flavor within each distinct consumer segment;
(e) generating, by the at least one processor, a flavor strategy report, including the impact of the at least one flavor within each distinct consumer segment; and
(f) outputting, by the at least one processor, the flavor strategy report.

8. The method according to claim 7, wherein the distinct consumer segments are selected from the group consisting of trailblazer, investigator, follower and hesitator.
